(19) United States
(12) Patent Application Publication
(10) Pub. No.: US 2025/0070627 A1
(43) Pub. Date: Feb. 27, 2025

(54) CONTROL DEVICE FOR ELECTRIC MOTOR

(71) Applicant: SAFEWAY INC., Seoul (KR)

(72) Inventors: DONG HO KIM, Gyeonggi-do (KR); JIN CHEOL HONG, Gyeonggi-do (KR)

(21) Appl. No.: 18/585,230

(22) Filed: Feb. 23, 2024

(30) Foreign Application Priority Data
Aug. 22, 2023 (KR) 10-2023-0109892

(51) Int. Cl. H02K 11/35; H02P 23/20; H02P 23/24

(52) U.S. Cl. CPC H02K 11/35; H02P 23/20; H02P 23/24

(57) ABSTRACT

A control device for an electric motor that outputs a control command for changing a direction of the electric motor provided with a handle, and starting, stopping, and decelerating the electric motor includes an enclosure that has a curved outer surface on a lower side and is attachable to and detachable from an outer surface of the handle, and a driving signal output unit that protrudes from a side portion of the enclosure and outputs at least one of starting and speed control commands of the electric motor.

### CROSS REFERENCE TO RELATED APPLICATION AND CLAIM OF PRIORITY

This application claims the benefit under 35 USC § 119 of Korean Patent Application No. 10-2023-0109892 filed on Aug. 22, 2023 in the Korean Intellectual Property Office, the entire disclosure of which is incorporated herein by reference for all purposes.

### BACKGROUND

### 1. Field

The present invention relates to a control device for an electric motor.

### 2. Description of Related Art

Recently, many transportation and mobility devices (e.g., electric strollers, electric keyboards, electric carts, etc.) using electric motors have been proposed. Such electric motor-type vehicles may perform operations such as starting on/off, deceleration, steering, and stop through a control device attached to a steering wheel or a separate location.

However, since the conventional electric motor rotates wheels when a driving button is continuously pressed, a user often has to continuously press the driving button while driving.

Therefore, the conventional electric motor has a problem in that a user should continuously press and hold a driving button, which may put a strain on fingers, and it is difficult to cope with unexpected situations since the electric motor decelerates at the moment the driving button was released rather than stopping quickly in the unexpected situations.

In addition, as the conventional electric motor is based on a method in which a user applies physical force to a handle when changing directions, a driving button should be continuously pressed using fingers or the like to drive a robot, which causes finger pain and requires a lot of physical strength.

### SUMMARY

The present invention provides a control device 100 for an electric motor that is installed on a handle 10 of the electric motor and is easy to operate without putting strain on a user's body.

The present invention may include the following embodiments in order to achieve the above object.

According to an embodiment of the present invention, a control device for an electric motor that outputs a control command for changing a direction of the electric motor provided with a handle, and starting, stopping, and decelerating the electric motor includes: an enclosure that has a curved outer surface on a lower side and is attachable to and detachable from an outer surface of the handle; and a driving signal output means that protrudes from a side portion of the enclosure and outputs at least one of starting and speed control commands of the electric motor.

The driving signal output means may be a push button that protrudes from the side portion of the enclosure.

The enclosure may include a horizontal portion that extends horizontally, a vertical portion that extends vertically downward, and a curved portion whose lower side is bent into a shape in close contact with an outer surface of the handle between the horizontal portion and the vertical portion.

The stop signal output means may be the push button that protrudes from one surface of a first block protruding from an opposite side of the enclosure.

The enclosure may include: an insertion groove that faces inward on the opposite side of the vertical portion; a first communication port that communicates with the insertion groove and is cut toward the horizontal portion; a second communication port that is cut on one surface facing the first communication port in a second block protruding downward from a lower surface of the horizontal portion; and a third communication port that is cut from a lower surface of the second block.

### BRIEF DESCRIPTION OF THE DRAWINGS

FIG. 1 is a block diagram illustrating an electric motor provided with a control device according to the present invention.

FIG. 2 is a block diagram illustrating the control device.

FIG. 3 is a perspective view illustrating the control device.

FIG. 4 is a side view of the control device.

FIGS. 5 and 6 are bottom views of the control device.

### DETAILED DESCRIPTION

A description for embodiments in this specification will be provided only to make the present invention complete and allow those skilled in the art to which the present invention pertains to completely recognize the scope of the present invention. The present invention is only defined by the scope of the claims.

Accordingly, in some embodiments, well-known components, well-known operations, and well-known technologies are not specifically described in order to avoid ambiguous interpretation of the present invention.

In addition, the same reference numerals refer to the same components throughout the specification, and the terms used (described) in the specification are for explaining embodiments and are not intended to limit the present invention.

In this specification, the singular also includes the plural unless specifically stated in the phrase, and elements and operations referred to as “including (or, comprising)” do not exclude the presence or addition of one or more other elements and operations.

Hereinafter, exemplary embodiments in the present invention will be described with reference to the accompanying drawings.

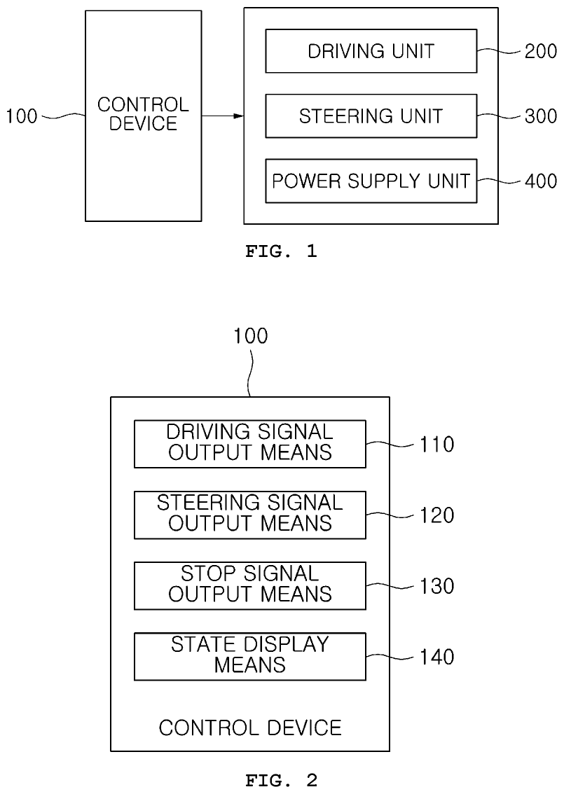

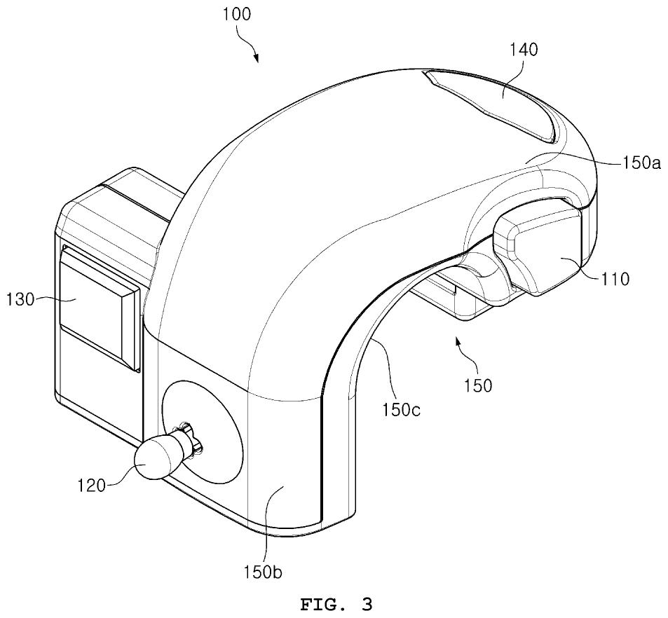

FIG. 1 is a block diagram illustrating an electric motor provided with a control device according to the present invention, and FIG. 2 is a block diagram illustrating the control device.

Referring to FIGS. 1 and 2, the electric motor includes a driving unit 200 that generates driving force to rotate a wheel, a steering unit 300 that controls a direction of the wheel, a power supply unit 400 that supplies power, and a control device 100 that outputs a control command.

The driving unit 200 may include an electric motor and a wheel connected to the electric motor. When power is supplied from the power supply unit 400, the electric motor rotates the wheel while rotating. In this case, a rotation speed of the driving unit 200 may increase or decrease depending on the control device 100, so a driving speed of the electric motor can be adjusted.

The steering unit 300 controls the direction of the wheel. The steering unit 300 controls the direction of the wheel according to the control command output from the control device 100.

The power supply unit 400 is, for example, either a rechargeable battery or a non-rechargeable battery, and may supply power according to the control command from the control device 100.

The electric motor may further include a braking device for emergency stopping or parking on a slope.

The control device 100 may be attached to the handle 10 of the electric motor to output at least one of steering, starting on/off, acceleration, deceleration, and stop commands.

Specifically, the control device 100 may include a driving signal output means 110 that outputs a driving signal, a steering signal output means 120 that outputs a steering control command, a stop signal output means 130 that outputs an emergency stop command, and a state display means 140 that displays state information of the electric motor and/or control device.

The driving signal output means 110 is, for example, a push button, and outputs a driving control command to the driving unit 200 and the power supply unit 400 when turned on by a user's manipulation.

The driving unit 200 is driven when the driving signal output means 110 is in an on state to increase a speed, or decelerates and stops when the driving signal output means 110 is in an off state. That is, the driving signal output means 110 maintains the on state to continuously output driving commands while driving.

The steering signal output means 120 outputs, for example, a steering control command in forward and left and right directions to the steering unit 300 of the electric motor. The command from the steering signal output means 120 is output to the steering unit 300, and the steering unit 300 changes a traveling direction of the wheel accordingly.

The stop signal output means 130 outputs an emergency stop command to the driving unit 200. The stop signal output means 130 is the push button and outputs the emergency stop command to a braking device.

Therefore, a user may use the stop signal output means 130 to suddenly stop the traveling of the electric motor in emergency or unexpected situations.

The state display means 140 is a plurality of light emitting means, and may display a state of the electric motor and/or an operating state of the driving signal output means 110 to the stop signal output means 130 as colored light. For example, the state display means 140 is an LED of R, G, and B, and may display, through light of different colors, state information such as at least one of on or off of the driving signal output means 110, an on and/or steering direction of the steering signal output means 120, and on of the stop signal output means 130, commands output from each control device 100, such as a charging state of the power unit and a current speed, and state information of the electric motor.

Alternatively, the state display means 140 may further include a guide lamp as a plurality of LEDs that illuminates toward the front.

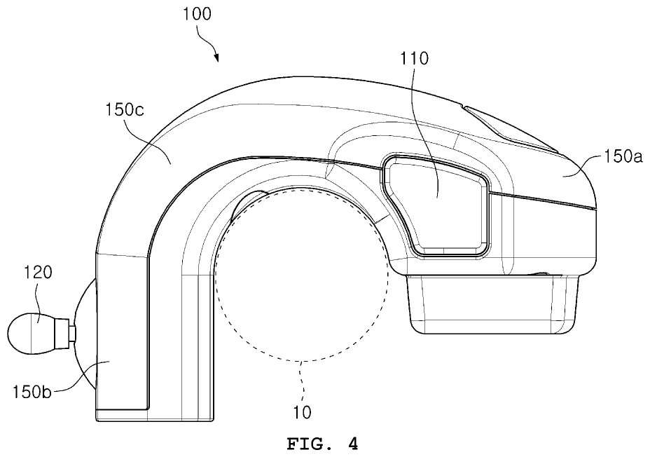

The mechanical configuration of the control device 100 having this configuration will be described in more detail with reference to FIGS. 3 to 5.

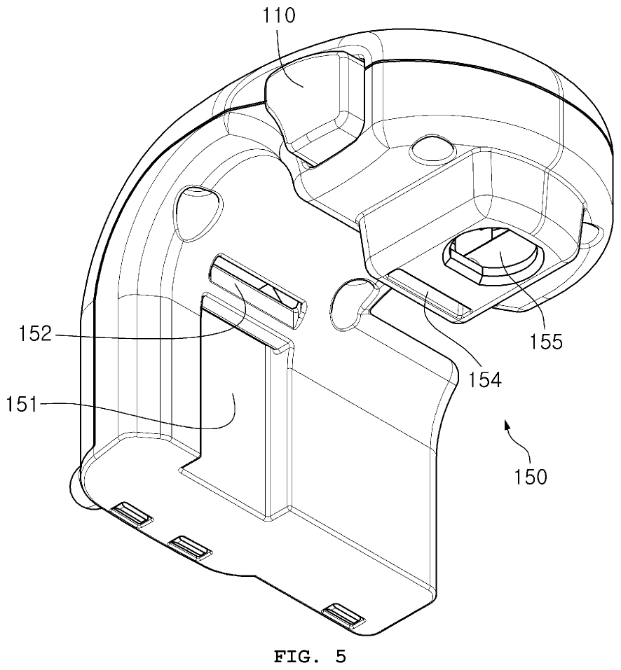

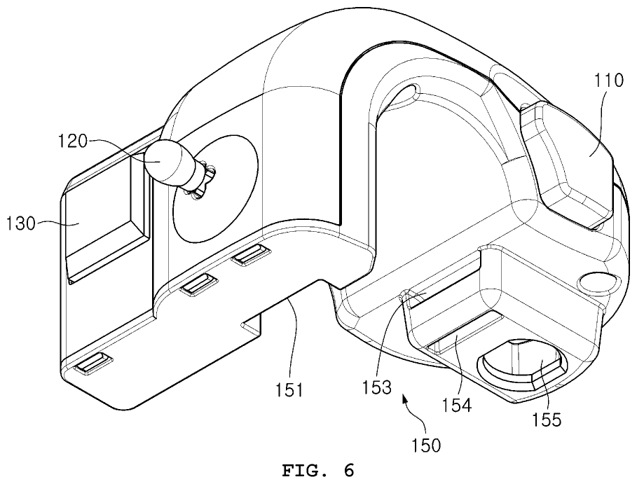

FIG. 3 is a perspective view illustrating the control device, FIG. 4 is a side portion view of the control device, and FIGS. 5 and 6 are bottom views of the control device.

Referring to FIGS. 3 to 6, the control device 100 forms an enclosure 150 having a bent shape, and may have a curved shape that matches an outer shape of the handle 10 so that it may be fitted into an outer surface of the handle 10 on a lower surface of a bent portion of the enclosure 150.

Specifically, the enclosure 150 includes a horizontal portion 150a that extends horizontally, a vertical portion 150b that extends vertically downward, and a curved portion 150c that is bent into a curved shape between the horizontal portion 150a and the vertical portion 150b.

The horizontal portion 150a may have the state display means 140 installed on one side of the upper surface, and the driving signal output means 110 may be installed in a protruding form on one side. Here, the driving signal output means 110 may be a push button on one side surface of the enclosure 150. The driving signal output means 110 has a position and shape such that it may be naturally pressed by a side portion of the user's hand when the user grips the handle 10.

That is, as the driving signal output means 110 is composed of the push button that protrudes from the side portion of the enclosure 150, the driving signal output means 110 may be pressurized by contacting when the user grips the handle 10, so it may continuously output the driving signals just by the user gripping the handle.

Therefore, the present invention may solve the problem that arises because the user has to keep pressing the driving button as in the related art.

The vertical portion 150b is configured as a wall vertically downward from the curved portion 150c, and one surface thereof is provided with the steering signal output means 120. Here, the steering signal output means 120 may be configured as a lever type (for example, a joy stick) that rotates and/or moves in front, rear, left, and right directions. This is to allow the user to grip the handle 10 with the other hand and easily change the direction of the electric motor with the opposite hand.

In addition, the vertical portion 150b may further include a first block (not numbered) protruding to the opposite side, and may be provided with the stop signal output means 130.

The stop signal output means 130 may be installed in the shape of the push button protruding on one surface of the first block (not numbered) protruding from the opposite side portion of the vertical portion 150b.

The curved portion 150c is formed in a bent shape between the horizontal portion 150a and the vertical portion 150b, and a lower surface thereof may be curved to match the outer surface of the handle 10. In this case, the curved portion 150c may further include a strap fastening structure that fixes the control device 100 to the outer surface of the handle 10.

For example, the strap is made of a material such as metal, fiber, leather, paper, and plastic, and its shape can be modified, and has a string or plate shape extending in one direction. The strap communicates with a lower surface of the curved portion 150c and is wrapped around the outer surface of the handle 10 to fix the control device 100 to the handle 10.

To this end, referring to FIG. 5, the lower surface of the curved portion 150c may include an insertion groove 151 that faces inward for fastening with the strap, a first communication port 152, a second communication port 153, and a third communication port 154.

The insertion groove 151 forms a space into or from which the strap, which is formed as an inward groove on the opposite surface of the vertical portion 150b, is inserted or extracted.

The first communication port 152 forms an opening opened toward the vertical portion 150b at an end of the insertion groove 151. That is, the insertion groove 151 and the first communication port 152 are formed on the opposite surface of the vertical portion 150b. Accordingly, the end of the strap may be inserted through the insertion groove 151 and drawn out to the first communication port 152, or the strap may be inserted into the first communication port 152 and drawn out to the outside through the insertion groove 151.

The second communication port 153 forms an opening opened on one side (the vertical portion 150b side) of a second block (not numbered) protruding downward from a lower surface of the horizontal portion 150a, and the third communication port 154 forms an opening cut from a lower side of the second block (not numbered) protruding downward.

Therefore, the control device 100 may be fixed to the outer surface of the handle 10 in a manner that the strap is inserted through the insertion groove 151, and one end of the strap drawn out to the first communication port 152 is drawn out by sequentially communicating with the second communication port 153 and the third communication port 154, and then fastened to the opposite end on the outer surface of the handle 10.

In addition, the curved portion 150c may include an outlet 155 through which one or more cables are drawn out from a lower surface of a block that protrudes downward from the lower surface of the horizontal portion 150a. The outlet 155 leads out electric wires connected to, for example, the driving signal output means 110, the steering signal output means 120, the stop signal output means 130, and the state display means 140.

The present invention may include the above configuration, and in particular, as the driving signal output means 110 is the push button and protrudes from a side portion of the control device 100, the user contacts and pressurizes the driving signal output means 110 while gripping the handle 10, so there is no problem in continuing to pressurize for driving as before.

In addition, according to the present invention, the steering signal output means 120 for changing the direction of the electric motor is configured as the lever type (e.g., a joy stick), and thus, may operate easily, and the steering signal output means 120 includes the emergency signal output means, and thus, may suddenly stop the electric motor in the unexpected situations.

Therefore, according to the present invention, it is possible to maintain the starting state of the electric motor even if the user does not apply excessive force, and improve convenience and safety by slowing down or stopping the electric motor even with the simple hand movement by the user.

In addition, even if the user does not apply additional physical force while naturally gripping the handle, the button of the electric motor is pressed and the starting state of the electric motor is maintained, and the force applied to the button of the electric motor is released as soon as the gripping of the handle is released, thereby safely stopping the electric motor.

Although the present invention has been described above with limited embodiments and drawings, the present invention is not limited thereto, and of course, various modifications and variations can be made by those skilled in the art to which the present invention pertains.

Those skilled in the art related to this embodiment will be able to understand that the embodiment may be implemented in a modified form without departing from the essential characteristics of the above description. Therefore, the embodiments disclosed herein should be considered in an illustrative aspect rather than a restrictive aspect. The scope of the present invention should be defined by the claims rather than the above-mentioned description, and equivalents to the claims should be interpreted to fall within the present invention.

What is claimed is:

1. A control device for an electric motor that outputs a control command for changing a direction of the electric motor provided with a handle, and starting, stopping, and decelerating the electric motor, the control device comprising:
an enclosure having a curved outer surface on a lower side, the enclosure being attachable to and detachable from an outer surface of the handle; and
a driving signal output unit protruding from a side portion of the enclosure, the driving signal output unit configured to output at least one of a starting command and a speed control command of the electric motor.

2. The control device of claim 1, wherein the driving signal output unit is a push button that protrudes from the side portion of the enclosure.

3. The control device of claim 1, further comprising:
a steering signal output unit configured to output a steering control command for the electric motor; and
a stop signal output unit configured to output an emergency stop command.

4. The control device of claim 3, wherein the enclosure includes a horizontal portion that extends horizontally, a vertical portion that extends vertically downward, and a curved portion whose lower side is bent into a shape in close contact with an outer surface of the handle between the horizontal portion and the vertical portion.

5. The control device of claim 4, wherein the steering signal output unit is of a lever type and is installed on one surface of the vertical portion.

6. The control device of claim 4, wherein the stop signal output unit is the push button that protrudes from one surface of a first block protruding from an opposite side of the enclosure.

7. The control device of claim 4, wherein the enclosure further includes:
an insertion groove that faces inward on the opposite side of the vertical portion;
a first communication port that communicates with the insertion groove and is cut toward the horizontal portion;
a second communication port that is cut on one surface facing the first communication port in a second block protruding downward from a lower surface of the horizontal portion; and
a third communication port that is cut from a lower surface of the second block.
